(19) United States
(12) Patent Application Publication
(10) Pub. No.: US 2026/0310589 A1
(43) Pub. Date: Oct. 8, 2026

(54) METHOD AND SYSTEM FOR GENERATING TEST SCENARIOS USING ARTIFICIAL INTELLIGENCE MODELS

(71) Applicant: SAMSUNG ELECTRONICS CO., LTD., Suwon-si (KR)

(72) Inventors: Karthik SRINIVASAN, Bengaluru (IN); Venkata Subbarao MANNE, Bengaluru (IN); Krishna Sumanth VEMURI, Bengaluru (IN); Sampathkumar M. BALLARY, Bengaluru (IN); Priyadarshini Panemangalore PAI, Bengaluru (IN); Manikantha Sasi Kiran MINGI, Bengaluru (IN)

(73) Assignee: SAMSUNG ELECTRONICS CO., LTD., Suwon-si (KR)

(21) Appl. No.: 19/638,685

(22) Filed: Apr. 3, 2026

(30) Foreign Application Priority Data
Apr. 4, 2025 (IN) 202541033328

(51) Int. Cl. G06F 11/3668; G06N 3/082; G06N 5/02

(52) U.S. Cl. CPC G06F 11/3684; G06N 3/082; G06N 5/02

(57) ABSTRACT

A method and a system for generating test scenarios using artificial intelligence (AI) models are disclosed. The method comprises extracting configurable parameters and operable constraints from system-on-chip (SoC) information; aggregating use case information from a dataflow, the parameters, and the constraints; identifying a hardware-software coordination mechanism; and generating a knowledge graph by creating a use case profile. A retrieval augmented generation agent and a path optimization agent are instantiated to retrieve domain-specific information and determine traversal paths through the knowledge graph, respectively. A test plan is generated based on the use case profile, the domain-specific information, and the traversal paths. The test plan is validated by a human-in-the-loop (HITL) verification agent and iteratively refined based on validation feedback. Finally, a plurality of test scenarios is generated based on the validated and refined test plan.

### CROSS-REFERENCE TO RELATED APPLICATION

This application based on and claims the benefit of Indian Provisional Application No. 202541033328, filed on Apr. 4, 2025, in the Indian Patent Office. The disclosure of which is incorporated herein in its entirety by reference.

### BACKGROUND

The present application relates to the field of generating test scenarios, and more particularly relates to a method and a system for generating test scenarios using one or more artificial intelligence (AI) models.

In advanced semiconductor manufacturing processes, the progressive shrinking of technology nodes has increased design density and complexity, thereby necessitating highly efficient constraint-solving mechanisms capable of rapidly generating wide-coverage test scenarios. Existing methodologies that rely on manual authoring, refinement, and resolution of constraints impose significant computational and operational burdens, making the overall process cumbersome, error-prone, and slow.

Verification of modern architectures, including system-on-chip (SoC) platforms, Intellectual Property (IP)-level blocks, and heterogeneous application processor (AP)/communication processor (CP)-based systems, requires handling deeply intertwined functional interactions across multiple processing engines and masters. Architecture-level validation and performance-verification tasks have become increasingly critical for eliminating post-silicon bottlenecks, particularly as the SoCs evolve into highly complex, multi-domain systems designed to satisfy diverse end-use requirements.

Current verification pipelines are heavily dependent on coordinated efforts among domain specialists, software developers, and validation engineers to construct, parameterize, and execute test scenarios at both the component-level and system-integration levels. Constraint definition rooted in domain knowledge, creation of test-case software for individual IPs, and orchestration of layered procedures across the AP/CP-based system software result in extensive manual overhead and significantly prolonged development cycles.

Existing test-scenario generation tools, constraint solvers, and system-verification frameworks exhibit multiple technical deficiencies, primarily summarized into three major challenges:

First challenge is that constraint documentation and test-solver development largely remain manual, requiring end-to-end human involvement. Incorporating AI-driven code generation and documentation capabilities, coupled with human-in-the-loop (HITL) validation, may substantially reduce the software-development workload and accelerate adoption across varying system domains.

Second challenge is that constraint-solver effectiveness relies heavily on expert-level domain knowledge. Dynamic incorporation of domain intelligence is essential to enable intelligent acceleration of constraint-solving operations. When historical data or system-level insights are available, artificial intelligence (AI) agents may optimize constraint usage, enhance recommendation accuracy, and orchestrate solver workflows more efficiently.

Third challenge is that current solutions lack a unified and adaptable framework capable of generalizing across different architectural domains. Transitioning between SoC-level and AP/CP-level verification environments remains laborious without an end-to-end system underpinned by an extensible knowledge base and a suite of cooperative AI agents. This absence of interoperability contributes to prolonged development timelines and increases resource requirements for developers and testers.

Although generative AI has enabled more efficient cross-domain learning and adoption, existing scenario-generation tools do not incorporate internal architectural information or low-level system-interaction details when producing scenario-based valid vectors. As a result, no current solution may generate architecture-aware, constraint-consistent test scenarios in an automated manner.

Therefore, there is a need for enhanced techniques to address the above-mentioned deficiencies.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

This summary is provided to introduce a selection of concepts, in a simplified format, that are further described in the detailed description of the disclosure. This summary is neither intended to identify key or essential inventive concepts of the disclosure, nor is it intended to determine the scope of the disclosure.

According to an embodiment, a method for generating test scenarios based on one or more artificial intelligence (AI) models is disclosed. The method includes extracting configurable parameters and operable constraints from system information of a system-on-chip (SoC). Further, the method includes aggregating use case information from a dataflow, the configurable parameters, and the operable constraints. Furthermore, the method includes identifying, based on the one or more AI models, a hardware-software coordination mechanism using the aggregated use case information. Additionally, the method includes generating, based on the one or more AI models, a knowledge graph by creating a use case profile based on the aggregated use case information and the hardware-software coordination mechanism. Moreover, the method includes instantiating at least a retrieval augmented generation (RAG) agent configured to retrieve domain-specific information from the knowledge graph. Still further, the method includes instantiating a path optimization agent configured to determine optimal traversal paths through the knowledge graph. Still further, the method includes generating, based on the one or more AI models, a test plan. The test plan is generated based on the use case profile, the domain-specific information, and the optimal traversal paths associated with the knowledge graph. Furthermore, the method includes validating, based on the one or more AI models, the test plan by a human-in-the-loop (HITL) verification agent. Accordingly, the method includes iteratively refining the test plan based on validation feedback from the HITL verification agent. Finally, the method includes generating, based on the one or more AI models, a plurality of test scenarios based on the validated and refined test plan.

According to an embodiment, a system for generating test scenarios based on one or more artificial intelligence (AI) models is provided. The system includes a memory and at least one processor. The at least one processor is in communication with the memory. The at least one processor is configured to extract configurable parameters and operable constraints from the system information of a system-on-chip (SoC). Further, the at least one processor is configured to aggregate use case information from a dataflow, the configurable parameters, and the operable constraints. Further, the at least one processor is configured to identify, based on the one or more AI models, a hardware-software coordination mechanism based on the aggregated use case information. Furthermore, the at least one processor is configured to generate, based on the one or more AI models, a knowledge graph. The knowledge graph is generated by creating a use case profile based on the aggregated use case information and the hardware-software coordination mechanism. Furthermore, the at least one processor is configured to instantiate at least a retrieval augmented generation (RAG) agent configured to retrieve domain-specific information from the knowledge graph. Additionally, the at least one processor is configured to instantiate a path optimization agent configured to determine optimal traversal paths through the knowledge graph. Moreover, the at least one processor is configured to generate, based on the one or more AI models, a test plan based on the use case profile, the domain-specific information, and the optimal traversal paths associated with the knowledge graph. Still further, the at least one processor is configured to validate, based on the one or more AI models, the test plan by a human-in-the-loop (HITL) verification agent. Accordingly, the at least one processor is configured to iteratively refine the test plan based on validation feedback from the HITL verification agent. Finally, the at least one processor is configured to generate, based on the one or more AI models, a plurality of test scenarios based on the validated and refined test plan.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF THE DRAWINGS

Features, aspects, and advantages of embodiments of the disclosure will be described below with reference to the accompanying drawings, in which reference numerals denote like elements, and wherein:

FIG. 1A illustrates an environment for the implementation of a system for generating test scenarios based on one or more artificial intelligence (AI) models, in accordance with one or more embodiments of the disclosure;

FIG. 1B illustrates the system for generating the test scenarios, in accordance with one or more embodiments of the disclosure;

FIG. 2 illustrates an example of a process flow of an end-to-end test case generation and constraint solving, in accordance with one or more embodiments of the disclosure;

FIG. 3A illustrates another example of a process flow of the end-to-end test case generation and constraint solving, in accordance with one or more embodiments of the disclosure;

FIG. 3B illustrates another example of a process flow of the end-to-end test case generation and constraint solving, in accordance with one or more embodiments of the disclosure;

FIG. 4 illustrates an example of graph knowledge used for constraint solving and scenario vector generation, in accordance with one or more embodiments of the disclosure; and

FIG. 5 illustrates a process flow of a method for generating the test scenarios based on the one or more AI models, in accordance with one or more embodiments of the disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments, and specific language will be used to describe the same. The embodiments described herein are non-limiting example embodiments. It will nevertheless be understood that no limitation of the scope of the disclosure is thereby intended, such alterations and further modifications in the illustrated system, and such further applications of the principles of the disclosure as illustrated therein, being contemplated as would normally occur to one skilled in the art to which the disclosure relates.

It will be understood by those skilled in the art that the foregoing general description and the following detailed description are explanatory of the disclosure and are not intended to be restrictive thereof.

Reference throughout this specification to “an aspect,” “another aspect,” or similar language means that a particular feature, structure, or characteristic described in connection with the embodiment is included in at least one embodiment of the present disclosure. Thus, appearances of the phrase “in an embodiment”, “in another embodiment”, and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or subsystems or elements or structures or components preceded by “comprises... a” does not, without more constraints, preclude the existence of other devices or other subsystems or other elements or other structures or other components or additional devices or additional subsystems or additional elements or additional structures or additional components.

As used herein, expressions “at least one of a, b, and c,” “at least one of a, b, or c,” and “a, b, and/or c” should be understood as including only a, only b, only c, both a and b, both a and c, both b and c, or all of a, b, and c.

The present disclosure relates to techniques for generating test scenarios based on an artificial intelligence (AI) model to overcome the limitations of conventional approaches. The present disclosure enables various phases of test case generation that may be done based on multiple AI Agents for effective planning and optimized action. Further, the present disclosure provides a method and a system with a multi-agent approach based on an AI model-based with human-in-the-loop (HITL) for constraint solving. Additionally, the disclosed method and system employ feedback loops, multiple interactions, and mechanisms for knowledge/domain/system adaptation, training, and evolving performance and user improvement.

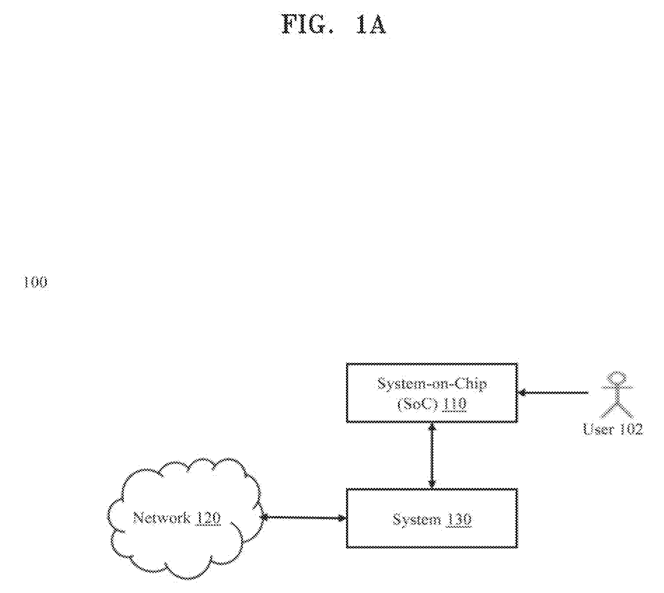

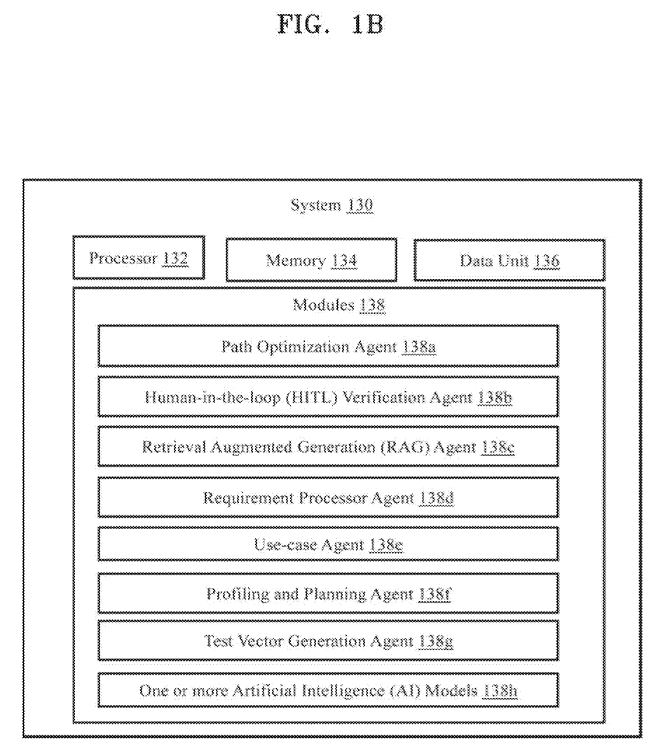

FIG. 1A illustrates an environment 100 for the implementation of a system 130 for generating test scenarios based on one or more artificial intelligence (AI) models 138h, in accordance with one or more embodiments of the disclosure.

In an exemplary embodiment, the environment 100 may comprise at least one user 102 operating a system-on-chip (SoC) 110. The at least one user 102 is interchangeably referred to hereinafter as “the user 102”. In a non-limiting example, the SoC 110 may include an electronic device such as, but not limited to, smartphones, laptops, and other smart devices. The SoC 110 may be connected with the system 130. The system 130 may be in communication with a network 120. In an embodiment, the SoC 110 may include at least one processor 132, a memory 134, a data unit 136, applications, sensors, peripherals such as, but not limited to imaging device, a microphone, and the like, and modules (not shown in FIG. 1A). In an embodiment, the SoC 110 may have the applications installed. The SoC 110 may be implemented based on the modules associated with the applications. Further, the modules may be in communication with the memory 134 and the at least one processor 132 of the SoC 110 to perform one or more functions associated with the generation of the test scenarios, as discussed herein. In another embodiment, the modules may be distributed across the SoC 110 and a server (not shown in the figure), as discussed throughout the present disclosure. The application may be indicative of a software package that performs a specific function for an end user. An operating system (OS) installed in the SoC 110 may typically present or display the application through a graphical user interface GUI of the SoC 110. In a non-limiting example, the SoC 110 may be a machine controllable through the network 120 and capable of executing a set of instructions (sequential or otherwise) that specify actions to be taken by that machine. In a non-limiting example, the network 120 may be interchangeably referred to as a wireless communication network. Further, the application may be installed in the SoC 110 for generating the test scenarios, as discussed throughout the present disclosure.

In an embodiment, the network 120 may include any type of communication network that enables data exchange between the SoC 110 and the system 130. In various embodiments, the network 120 may comprise one or more of a wired network, a wireless network, or a combination of a wired and wireless network. Examples of the network 120 may include, but are not limited to, a local area network (LAN), a wide area network (WAN), the Internet, an intranet, a metropolitan area network (MAN), cellular communication networks, wireless fidelity (Wi-Fi) networks, Bluetooth, ZigBee, Near-Field Communication (NFC) networks, machine-to-machine (M2M) networks, or other similar communication infrastructures.

In an embodiment, the system 130 may be configured to provide a framework that may enable automatic generation of test scenarios with wide coverage while reducing manual efforts. Furthermore, the system 130 may dynamically adapt to different domains and systems with minimal reconfiguration. Additionally, the system 130 may leverage the knowledge graphs and path optimization for efficient constraint solving and the test plan generation. The system 130 may also incorporate human verification at critical stages to ensure accuracy and relevance of generated test scenarios. In an advantageous aspect, the system 130 may provide a multi-agent approach based on one or more AI models with human-in-the-loop (HITL) for architecture-aware, knowledge graph-based constraint solving and scenario vector generation.

FIG. 1B illustrates the system for generating the test scenarios, in accordance with one or more embodiments of the disclosure.

In an embodiment, the system 130 may include at least one processor 132, a memory 134, a data unit 136, and a plurality of modules 138. The plurality of modules 138 may include, but not limited to, a path optimization agent 138a, a human-in-the-loop (HITL) verification agent 138b, a retrieval augmented generation (RAG) agent 138c, a requirement processor agent 138d, a use-case agent 138e, a profiling and planning agent 138f, a test vector generation agent 138g, and one or more artificial intelligence (AI) models 138h.

In an embodiment, the at least one processor 132 of the system 130 may be in communication with the memory 134. The at least one processor 132 may be configured to execute instructions stored in the memory 134 and to perform various processes for generating the test scenarios, as discussed throughout the disclosure. The at least one processor 132 may be configured to initiate or stop one or more routines or a process-based generation of the test scenarios. The at least one processor 132 may be a single processing unit or several units, either of which may include multiple computing units. The at least one processor 132 may be implemented as one or more of the following: microprocessors, microcomputers, microcontrollers, digital signal processors (DSPs), central processing units (CPUs), an application processor (AP), a graphics-only processing unit such as a graphics processing unit (GPU), a visual processing unit (VPU), an Artificial intelligence (AI) dedicated processor such as a neural processing unit (NPU), state machines, logic circuitries, and/or any other devices that manipulate signals based on operational instructions. Among other capabilities, the at least one processor 132 may be configured to fetch and execute computer-readable instructions and data stored in the memory 134.

In an embodiment, the memory 134 may store instructions to be executed by the at least one processor 132, respectively, for the generation of the test scenarios, as discussed throughout the disclosure. The memory 134 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 134 may, in some examples, be considered a non-transitory storage medium. The term “non-transitory” may indicate that the storage medium is not embodied in a carrier wave or a propagated signal. However, the term “non-transitory” should not be interpreted as the memory 134 is non-movable. In some examples, the memory 134 may be configured to store larger amounts of information. In certain examples, a non-transitory storage medium may store data that can, over time, change (e.g., in Random Access Memory (RAM) or cache). The memory 134 may be internal storage units, or external storage units of the at least one processor 132, a cloud storage, or any other type of external storage.

In an embodiment, the data unit 136, amongst other things, may include routines, programs, objects, components, data structures, and the like, which may help in performing particular tasks or implementing data types. The data unit 136 may be implemented as one of or a combination of signal processors, state machines, logic circuitries, or other devices/components that manipulate signals based on operational instructions. Further, the data unit 136 may be implemented in hardware, instructions executed by a processing unit, or by a combination thereof.

In some example embodiments, a function associated with the various components of the system 130 may be performed through the non-volatile memory, the volatile memory, and the at least one processor 132. The at least one processor 132 may control the processing of input data associated with the generation of the test scenarios in accordance with a predefined operating rule or the one or more AI models 138h stored in the non-volatile memory and the volatile memory. The predefined operating rule or one or more AI models 138h may be provided through training or learning. Here, being provided through learning means that, by applying a learning technique to a plurality of learning data, a predefined operating rule or one or more AI models 138h of the desired characteristic is generated. The learning may be performed or implemented in the system 130 in which AI may be performed or implemented, and/or the learning may be performed or implemented through a separate server or system. The learning technique may be a method for training the plurality of modules 138 based on a plurality of learning data to cause, allow, or control the system 130. Examples of learning algorithms include, but are not limited to, supervised learning, unsupervised learning, semi-supervised learning, or reinforcement learning.

The one or more AI models 138h may consist of a plurality of neural network layers. Each layer has a plurality of weight values and performs a layer operation through a calculation of a previous layer and an operation of a plurality of weights. Examples of neural networks include, but are not limited to, Convolutional Neural Networks (CNNs), Deep Neural Networks (DNNs), Recurrent Neural Networks (RNNs), Restricted Boltzmann Machines (RBMs), Deep Belief Networks (DBNs), Bidirectional Recurrent Deep Neural Networks (BRDNNs), Generative Adversarial Networks (GANs), and deep Q-networks.

In an embodiment, the at least one processor 132 may be configured to execute the plurality of modules 138 that may work in coordination to generate optimized test scenarios.

In an embodiment, the at least one processor 132 may be configured to extract configurable parameters and operable constraints from the system information of the SoC 110. The system information may include hardware specifications, software configurations, architectural details, test scenarios, constraints, and infrastructure availability. In a non-limiting example, there may be many associated blocks and sub-blocks, such as a camera in multimedia, for the SoC 110. Further, the SoC may have certain allowed operable conditions which may be extracted as the configurable parameters.

In an embodiment, the at least one processor 132 may be configured to aggregate use case information from a dataflow, the configurable parameters, and the operable constraints. In an implementation, the use case information aggregated from the dataflow may include one or more data path definitions for decoding a chain-level details, an IP-level linkage, and operational modes associated with the SoC 110. For example, the SoC 110 may have multiple subsystems, and each subsystem may have multiple intellectual properties (IPs) grouped based on common functionality, like a camera subsystem, display subsystem, and the like. An IP level linkage may indicate a way of interconnection of the multiple IPs in the subsystem. The IP level linkage may be used to accomplish the required functionality, which may be defined as linkage. In a non-limiting example, to check for the camera operability in low-light conditions, all the hardware specifications may be required to be collected. Additionally, parameters may be selected for low-light condition suitability, implying all common operations parameters and those pertaining to low-light operations may be selected for further data flow.

In an embodiment, the at least one processor 132 may be configured to identify, based on the one or more AI models 138h and the aggregated use case information, a hardware-software coordination mechanism. In an implementation, the one or more AI models 138h, which may include or utilize a generative AI model, a large-language-model (LLM), or any neural-network-based reasoning engine may utilize at least one of historical data, domain knowledge, and constraint definition records to generate a pattern-aware constraint encoding. In a non-limiting example, based on the historical data, the domain knowledge, and the constraint definition records comprising conventional manual/semi-automated constraint definition records, the generative AI model may be used to devise a prompt for automatically generating a pattern-aware constraint writing method. The pattern-aware constraint writing method may help in encoding all the constraints that may be suitable for low-light camera operability only.

In an embodiment, the at least one processor 132 may be configured to generate, based on the one or more AI models, the knowledge graph. Generating the knowledge graph is further based on creating a use case profile based on the aggregated use case information and the hardware-software coordination mechanism. The use case profile may represent the mapping of aggregated use‑case information to system entities, constraints, and operational modes. In a non-limiting example, the following may be taken into consideration when generating the use case profile: the constraints, applicable test plan (such as range of low-light conditions), corresponding design parameters, and the like. Further, the knowledge graph, containing the system components and the values of operation, may be populated. In a non-limiting example, a knowledge base may be used, which may comprise a database, a graph database, the knowledge graph, or any other such intelligent data storage and retrieval component. The retrieval component may be generated and refined through data intelligence provided by domain experts, or data intelligence may be recommended through an LLM based on user input or system awareness.

In an embodiment, the at least one processor 132 may be configured to instantiate the RAG agent 138c. The RAG agent 138c may be configured to retrieve domain-specific information from the knowledge graph. Further, the at least one processor 132 may be configured to instantiate the path optimization agent 138a. The path optimization agent 138a may be configured to determine optimal traversal paths through the knowledge graph. The instantiation may include a hardware architecture-aware selective navigation path optimization mechanism for reducing the size of the knowledge graph and generating the test plan based on the use case profile and the knowledge graph.

In an embodiment, the at least one processor 132 may be configured to generate a test plan based on the use case profile, the domain-specific information, and the optimal traversal paths associated with the knowledge graph. The test plan may be generated based on the one or more AI models 138h. In an implementation, the at least one processor 132 may be configured to generate the test plan based at least on the logical reasoning and inductive input processing capabilities of the processor. In a non-limiting example, the test vector generation agent 138g may use the knowledge graph and sub-graphs or graph transformers with or without logical reasoning or inductive inputs. The graph transformers may cover or be expanded to increasingly supervised forms as iterative solution improvers. The graph transformers may have recurrence information to include reasoning.

In an embodiment, the at least one processor 132 may be configured to generate a plurality of test scenarios based on the test plan. The plurality of test scenarios may be generated based on the one or more AI models 138h. In a non-limiting example, for the given optimized test plan and domain knowledge, suitable test cases in a wide spectrum of conditions may be generated to check camera performance under low-light conditions. In an advantageous aspect, to achieve higher scenario coverage, random scenario vector creation based on inputs received from the user 102 may be implemented to regress with multiple random vectors.

In an embodiment, the at least one processor 132 may be configured to validate, based on the one or more AI models 138h, the test plan by the HITL verification agent 138b. The at least one processor 132 may be configured to iteratively refine the test plan based on validation feedback from the HITL verification agent 138b. In response to the validated test plan, the at least one processor 132 may generate a plurality of test scenarios, which may include random scenario vectors generated based on a user input. In an implementation, the HITL verification agent 138b may be configured to evaluate the test plan based on one or more metrics associated with at least one of predicted scenario coverage, relevance to use case requirements, and constraint satisfaction accuracy. In a non-limiting example, the one or more AI models 138h or a domain expert may evaluate various metrics including coverage, relevance, accuracy and faithfulness. The iterative refining of the test plan based on validation feedback comprises feedback for at least one of knowledge adaptation, domain adaptation, and system adaptation.

In an embodiment, the at least one processor 132 may be configured to implement a pruning strategy, based on properties of symmetry, to reduce a search space during constraint solving of the knowledge graph, wherein the pruning strategy may comprise a Max-restricted path consistency mechanism.

In an embodiment, the at least one processor 132 may be configured to implement one or more graph processing techniques. The one or more graph processing techniques may comprise at least one of an intelligent topological search, an adaptive awareness‑based path finding, a depth‑first graph traversal, a breadth‑first graph traversal, a hardware‑based selective navigation, and an intelligent acceleration technique.

In an embodiment, the at least one processor 132 may be configured to iteratively refine the plurality of test scenarios generation based on validation feedback, which comprises feedback for at least one of knowledge adaptation, domain adaptation, and system adaptation.

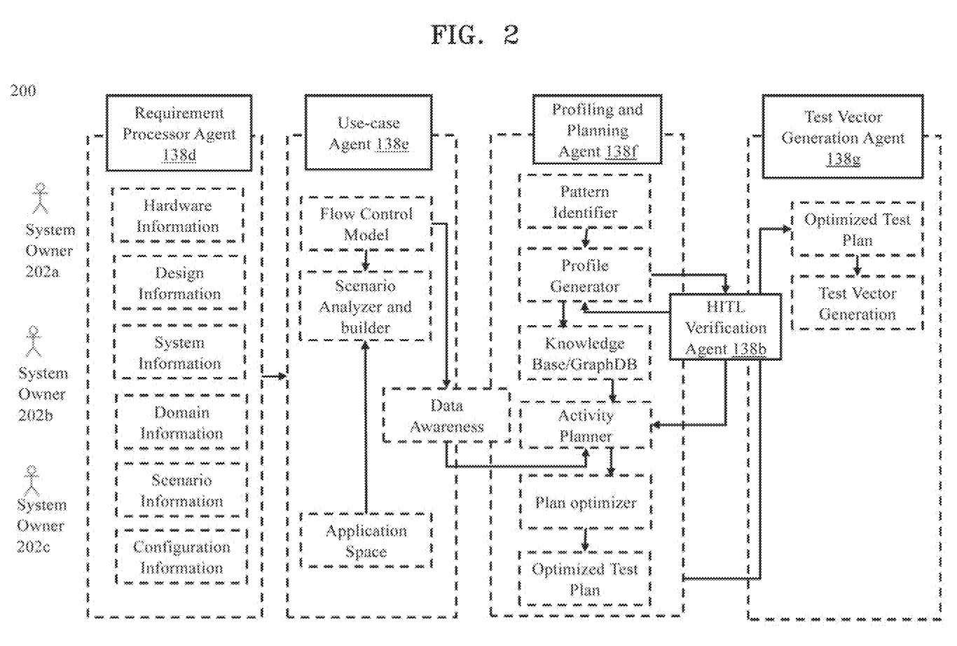

FIG. 2 illustrates an example of a process flow 200 of an end-to-end test case generation and constraint solving, in accordance with one or more embodiments of the disclosure.

In an embodiment, FIG. 2 shows an AI‑driven verification and test‑generation process flow 200 based on the plurality of modules 138 of the system 130. The plurality of modules 138, such as the requirement processor agent 138d, the use-case agent 138e, the profiling and planning agent 138f, the test vector generation agent 138g, and the HITL verification agent 138b, of the system 130 may operate sequentially and collaboratively to transform heterogeneous system information into optimized test plans and executable test vectors. At the input stage, one or more system owners 202a - 202c may provide various forms of information to the requirement processor agent 138d. In a non-limiting example, the one or more system owners 202a - 202c may include domain experts, validation engineers, or architects. The requirement processor agent 138d may act as a central processing pipeline where all the information may be ingested in parallel. The various forms of information ingested may include hardware information, design information, system information, domain information, scenario information, and configuration information. The requirement processor agent 138d may be driven by the one or more AI models 138h. In an implementation, the requirement processor agent 138d may collect and interpret all available knowledge from the one or more system owners 202a - 202c or stakeholders, such as architectural constraints, intended behaviors, infrastructure capabilities, and test goals. Further, the requirement processor agent 138d may normalize the collected information for downstream processing.

The refined information from the requirement processor agent 138d may transition into the use-case agent 138e. The refined information may help the one or more system owners 202a - 202c in understanding an expected behavior of the system 130 under practical conditions. Based on the refined information, the use-case agent 138e may interact with analytical components such as a scenario analyzer and builder to decompose the scenario into executable segments. Further, the use-case agent 138e may receive application space to identify feasible operational contexts. Further, the use-case agent 138e may provide data awareness, which may contextualize system data patterns relevant to a specific use case.

The data awareness from the use-case agent 138e may transition into the profiling and planning agent 138f. The use-case agent 138e may take in the application space data to perform mapping to low-level dataflows after considering the requirements from the profiling and planning agent 138f. A pattern identifier within the profiling and planning agent 138f may further extract recurring behavioral or architectural patterns, while a profile generator in the profiling and planning agent 138f may synthesize the architectural patterns and scenario attributes into a formal use-case profile. Further, supporting structures, such as the knowledge base or graph database, may provide historical and relational context, enabling the profiling and planning agent 138f to reason over system dependencies. Additionally, an activity planner and a plan optimizer may help the system 130 in generating and refining activity flows aligned with constraints and capabilities. Thus, the profiling and planning agent 138f, in collaboration with the use-case agent 138e, may construct dynamic system profiles and establish a structured test plan using both frozen and newly received data. The profiling and planning agent 138f may synthesize hardware-software interactions, usage scenarios, and constraint patterns into a unified planning model.

The output from the profiling and planning agent 138f may be forwarded to the HITL verification agent 138b to validate each step of the planning, ensuring alignment with actual system behavior. The HITL verification agent 138b may use updated information gathered from the profile generator to instruct the activity planner to verify the logical consistency and feasibility of steps. The HITL verification agent 138b may continuously refine the plan by correcting deviations, ensuring that the eventual test plan reflects both real-world constraints and stakeholder requirements. Once verification and optimization are complete, the refined plan may be passed to the test vector generation agent 138g. The test vector generation agent 138g may transform optimized test plans into executable scenarios, concrete test steps, and system-state transitions. The test vector generation agent 138g may leverage an optimized test plan and the test vector generation to resolve individual test cases, generate scenario-specific vectors, and prepare actionable outputs for testers or automated execution systems. Output from the test vector generation agent 138g may represent the final deliverable, fully validated, context‑aware, constraint‑compliant test vectors.

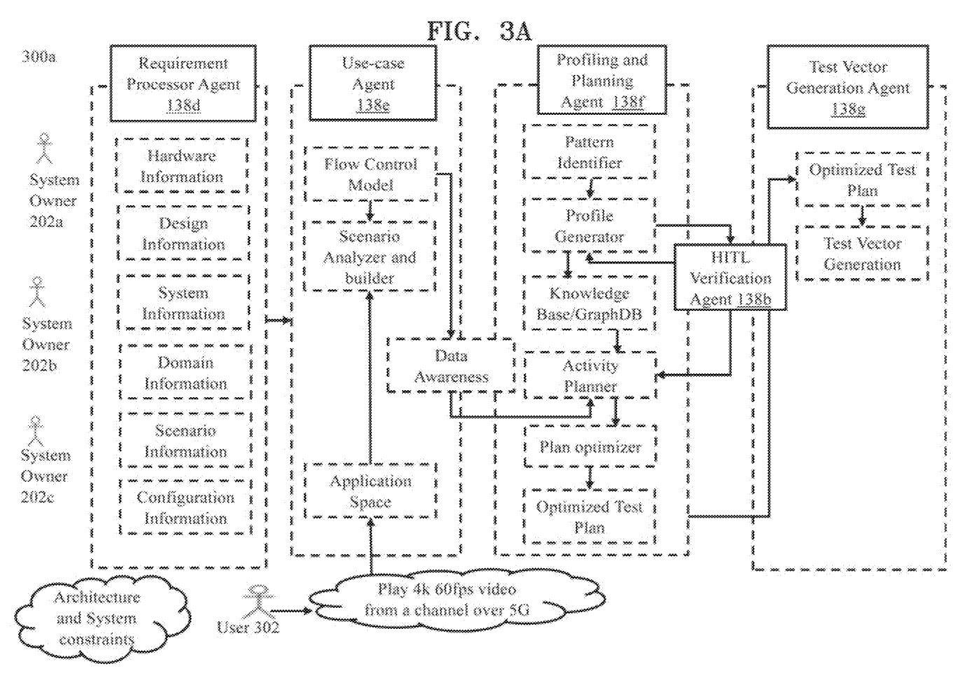

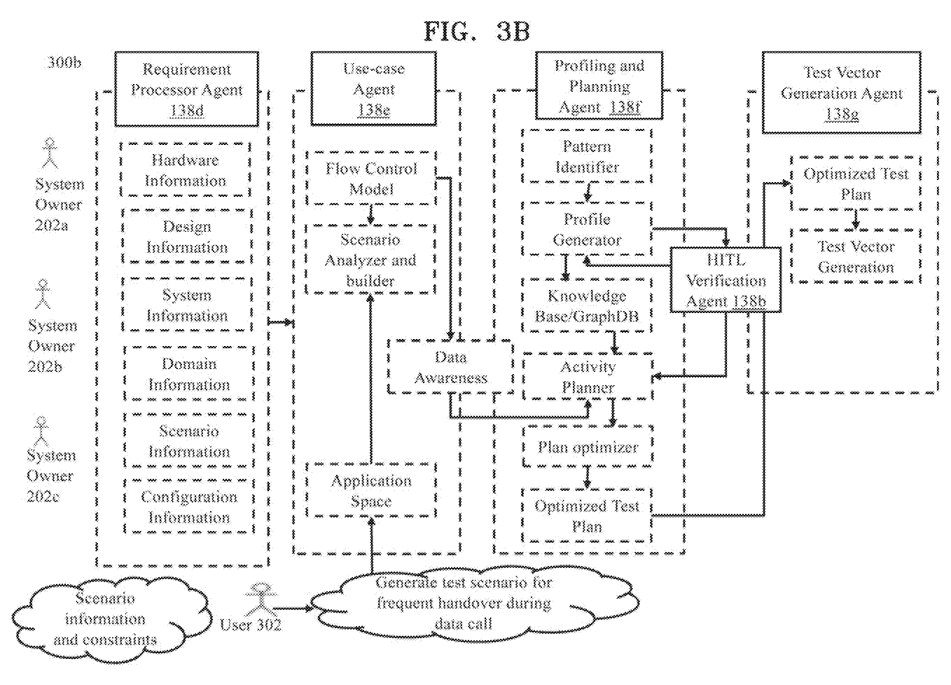

FIG. 3A illustrates another example of a process flow of the end-to-end test case generation and constraint solving, in accordance with one or more embodiments of the disclosure.

In an exemplary embodiment, in furtherance of FIG. 2, FIG. 3A shows that the system 130 may be configured to generate test scenarios for playing a 4K 60fps video from a channel over a fifth-Generation (5G) network. The use-case agent 138e may take in the application space data and perform the mapping to hardware-level dataflows after considering chip architecture and system-level constraints. The hardware level dataflow may include network to media packet components, including a modem application processor (ModAP), the DRAM, the CPU, a display panel, a display processing unit (DPU), and a multi‑format codec (MFC), along with application space memory on the CPU. The ModAP may be responsible for modem‑related application tasks in application processor (AP)/communication processor (CP)-based systems. The DRAM may be used for high‑speed read/write operations. The CPU may be a general‑purpose processing core executing system software and applications. Further, the display panel may be a hardware component responsible for rendering visual output. The DPU may be a dedicated processor for composition, scaling, color correction, and rendering operations for display pipelines. Furthermore, the MFC may be a hardware video codec engine capable of decoding AV1 video streams.

FIG. 3B illustrates another example of a process flow of the end-to-end test case generation and constraint solving, in accordance with one or more embodiments of the disclosure.

In an exemplary embodiment, in furtherance of FIG. 2, FIG. 3B shows that the system 130 may be configured to generate test scenarios for frequent handovers during a data call. The user 102 may provide a prompt requesting the generation of a test scenario for frequent handovers during the data call. Accordingly, the system 130 may be configured to process the prompt requesting the generation of the test scenario through the multi-agent pipeline to generate appropriate test vectors.

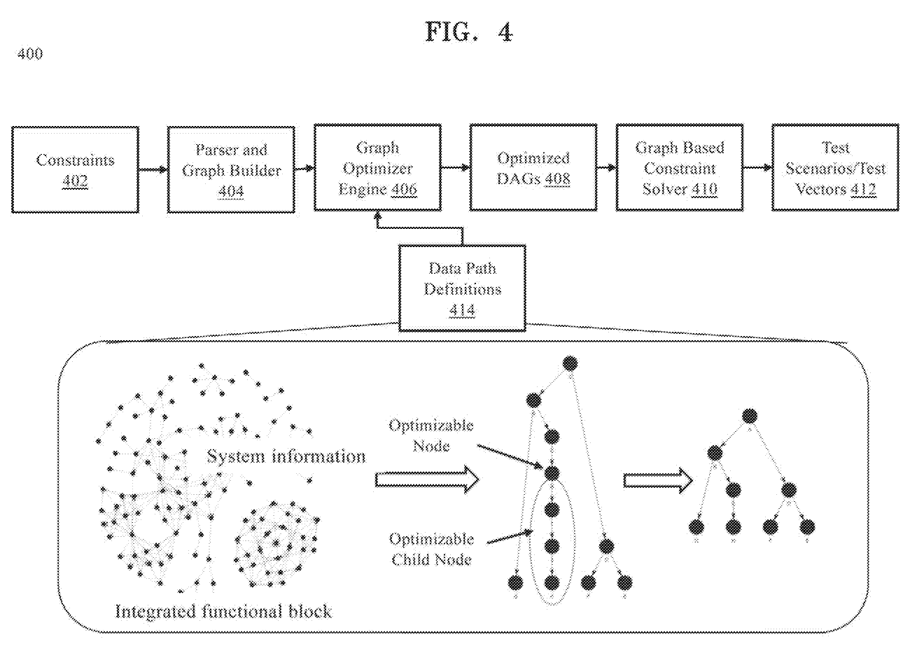

FIG. 4 illustrates an example of the graph-based knowledge used for constraint solving and scenario vector generation, in accordance with one or more embodiments of the disclosure.

In an embodiment, as referred to in FIG. 4, the system 130 may use a graph-based knowledge structure to perform both constraint solving and scenario vector generation. The graph-based knowledge structure may represent an integrated functional block comprising at least one of hardware blocks, software components, configurable parameters, and operational states of the SoC 110 as nodes in the graph. The relationships, dependencies, and allowable transitions between these elements may be modeled as edges in the graph. When a test scenario needs to be generated, the graph may enable the system 130 to intelligently navigate through the permissible combinations of parameters and operational paths. In an implementation, constraints 402 may represent all limitations, boundary conditions, operational parameters, and system rules that must be satisfied during planning, optimization, and test generation. These constraints 402 may arise from hardware, software, configuration, timing, safety limits, or architectural requirements. Further, constraints 402 may directly influence the overall graph that is constructed and optimized. The constraint set 402 may ensure that any optimized test vector remains feasible and compliant with system specifications. The constraints 402 may be forwarded to a parser and graph builder 404. The parser and graph builder 404 may be responsible for translating raw system information into a formal graph representation. The parser and graph builder 404 may parse constraints, node definitions, system data, and relationships, to construct an interconnected graph structure that

may capture all optimizable and dependent nodes within the system 130. The graph may serve as a foundational model for subsequent optimization and scenario generation. The graph from the parser and graph builder 404 may be forwarded to a graph optimizer engine 406. The graph optimizer engine 406 may perform optimization operations on the graph constructed by the parser and graph builder 404. The graph optimizer engine 406 may utilize data path definitions 414 to generate optimized directed acyclic graphs (DAGs) 408. The data path definitions 414 may provide information regarding optimizable nodes and optimizable child nodes. The optimizable child nodes may be the nodes within the graph. The optimizable node may represent an individual functional block, step, or operation within the system‑under‑test that may undergo optimization based on constraints, dependencies, or desired performance characteristics. Each optimizable child node may be a subordinate or dependent node linked to a parent optimizable node, representing hierarchical or sequential dependencies within the system’s operational flow. The presence of parent‑child relationships may enable the graph optimizer engine 406 to understand causality, prerequisites, and execution order between system operations. The graph optimizer engine 406 may analyze node relationships, constraints, and structural patterns to generate the optimized DAGs 408. The optimized DAGs 408 may reduce redundancy, improve execution efficiency, and identify the most effective operational sequences. The graph optimizer engine 406 may apply the one or more AI models 138h to derive optimal traversal paths through the system model. Further, the graph-based constraint solver 410 may be used to rapidly prune invalid states by incorporating constraint rules into the graph. Such constraints rules may include at least one of system limits, use-case-specific conditions, or hardware-dependent restrictions. Further, the graph-based constraint solver 410 may focus on viable paths and reduce the complexity involved in exploring large configuration spaces. The graph may also serve as the foundation for a scenario vector generator. The scenario vector generator of the system 130 may identify meaningful sequences of operations that may be test scenarios or test vectors by using at least one of graph traversal techniques, path-finding techniques, and graph transformers. The graph transformers are machine learning (ML)-based models operating on graph‑structured data, the scenario vector generator of the system 130 may identify meaningful sequences of operations that may be test scenarios or test vectors 412. The test scenario or test vectors 412 may satisfy all domain-specific constraints. In an advantageous aspect, the graph-based knowledge structure may enable efficient generation and ensure logical consistency, domain awareness, and high coverage, since diverse paths through the graph correspond to diverse test scenarios.

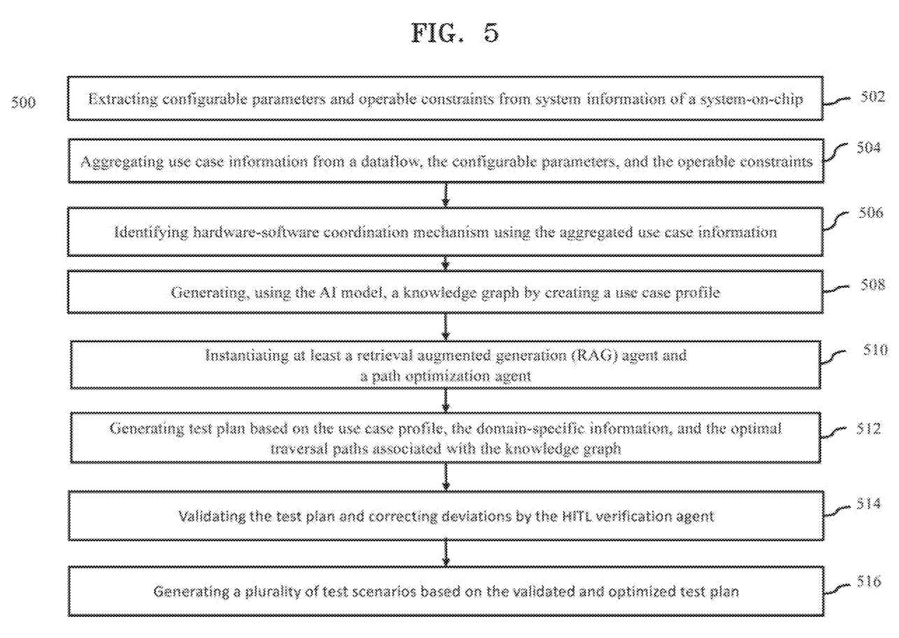

FIG. 5 illustrates a process flow of a method for generating the test scenarios based on the one or more AI models, in accordance with one or more embodiments of the disclosure.

The method 500 may be a computer-implemented method executed, for example, by the system 130. For the sake of brevity, the constructional and operational features of the system 130 that are already explained in the description of FIGS. 1 - 4 are not explained in detail in the description of FIG. 5.

At step 502, the method 500 may include extracting the configurable parameters and the operable constraints from the system information of the SoC 110. The system information may include hardware specifications, software configurations, architectural details, the plurality of test scenarios, the data path-aware constraints, and the infrastructure availability.

At step 504, the method 500 may include aggregating the use case information from the dataflow, the configurable parameters, and the operable constraints. In an implementation, the use case information, which may be aggregated from the dataflow, may comprise the one or more data path definitions for decoding the chain-level details, the IP level linkage, and the operational modes associated with the SoC 110.

At step 506, the method 500 may include identifying, based on the one or more AI models 138h and the aggregated use case information, the hardware-software coordination mechanism , the one or more AI models 138h may include the generative AI model. The generative AI model may generate the pattern-aware constraint encoding based on at least one of the historical data, the domain knowledge, and the constraint definition records for generating the pattern-aware constraint encoding.

At step 508, the method 500 may include generating, based on the one or more AI models 138h, the knowledge graph. Generating the knowledge graph further comprises creating the use case profile based on the aggregated use case information and the hardware-software coordination mechanism.

At step 510, the method 500 may include instantiating the RAG agent 138c configured to retrieve domain-specific information from the knowledge graph. Further, the method 500 may include instantiating the path optimization agent 138a configured to determine optimal traversal paths through the knowledge graph.

At step 512, the method 500 may include generating the test plan based on the one or more AI models 138h, the domain-specific information, and the optimal traversal paths associated with the knowledge graph. The optimal traversal paths may include applying the hardware architecture-aware data path optimization mechanism, for reducing the size of the knowledge graph, and generating the test plan based on the use case profile and the knowledge graph. The test plan may be generated further based on at least one of the logical reasoning and the inductive input processing capabilities of the at least one processor 132.

At step 514, the method 500 may include validating the test plan, based on the one or more AI models 138h and the HITL verification agent 138b. The method 500 may iteratively refine the test plan based on validation feedback from the HITL verification agent 138b. The iterative refining may include feedback for at least one of the knowledge adaptation, the domain adaptation, and the system adaptation.

At step 516, the method 500 may include generating, based on the one or more AI models 138h and the validated and optimized test plan, the plurality of test scenarios, The plurality of test scenarios are generated to reflect real-world constraints and stakeholder requirements confirmed during the validation at step 514.

In an implementation, the HITL verification agent 138b may be configured to evaluate the plurality of test scenarios using at least one of the relevance to use case requirements, the constraint satisfaction accuracy, and one or more metrics associated with the predicted scenario coverage. The plurality of test scenarios comprises random scenario vectors generated based on a user input.

Further, the method 500 may include implementing the pruning strategy, based on properties of symmetry, for reducing the search space during constraint solving of the knowledge graph. The pruning strategy may include, but not be limited to, the max-restricted path consistency mechanism.

Further, the method 500 may include implementing the one or more graph processing techniques, such as, but not limited to, the intelligent topological search, the adaptive awareness-based path finding, the depth-first graph traversal, the breadth‑first graph traversal, the hardware architecture-based selective navigation, and the intelligent acceleration technique.

In an exemplary embodiment, the individual steps of the method 500 may be generated by the one or more AI models 138h. The one or more AI models 138h may be using the LLM and verified through the domain experts or entirely provided by the domain experts.

### Based on the embodiments discussed above, the following advantages may be achieved

The method and system of present disclosure enable architecture-aware, AI-assisted, and domain-adaptive generation of test scenarios with minimal manual intervention. The system 130 and method 500 enhance domain adaptability and resource efficiency by learning from available data, especially when advanced computational infrastructure is present. The multi‑agent architecture of the system 130, combined with HITL verification, ensures both automation efficiency and result reliability. Furthermore, the knowledge‑graph‑based processing supports highly efficient constraint solving and path optimization, lowering computational overhead. Overall, the system 130 and method 500 offer exceptional scalability and adaptability, making it suitable for varied SoC architectures and evolving testing requirements.

While specific language has been used to describe the disclosure, any limitations arising on account of the same are not intended. As would be apparent to a person in the art, various working modifications may be made to the method to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

What is claimed is:

1. A method for generating test scenarios, the method comprising:
extracting configurable parameters and operable constraints from system information of a system-on-chip;
aggregating use case information from a dataflow, the configurable parameters, and the operable constraints;
identifying, based on one or more artificial intelligence (AI) models, a hardware-software coordination mechanism based on the aggregated use case information;
generating, based on the one or more AI models, a knowledge graph, wherein generating the knowledge graph comprises creating a use case profile based on the aggregated use case information and the hardware-software coordination mechanism;
instantiating at least a retrieval augmented generation agent configured to retrieve domain-specific information from the knowledge graph and a path optimization agent configured to determine traversal paths through the knowledge graph;
generating, based on the one or more AI models, a test plan based on the use case profile, the domain-specific information, and the traversal paths associated with the knowledge graph;
validating, based on the one or more AI models, the test plan by a human-in-the-loop verification agent;
iteratively refining the test plan based on validation feedback from the human-in-the-loop verification agent; and
generating, based on the one or more AI models, a plurality of test scenarios based on the validated and refined test plan.

2. The method as claimed in claim 1, wherein the one or more AI models comprises a generative AI model,
wherein the generative AI model utilizes at least one of historical data, domain knowledge, and constraint definition records for generating a pattern-aware constraint encoding.

3. The method as claimed in claim 1, wherein instantiating the path optimization agent for determining the traversal paths comprises applying a hardware architecture aware data path optimization mechanism for reducing size of the knowledge graph and generating the test plan based on the use case profile and the knowledge graph.

4. The method as claimed in claim 1, wherein generating the test plan is based on at least logical reasoning and inductive input processing capabilities.

5. The method as claimed in claim 1, further comprising:
implementing a pruning strategy, based on properties of symmetry, for reducing a search space during constraint solving of the knowledge graph, wherein the pruning strategy comprises a max-restricted path consistency mechanism.

6. The method as claimed in claim 1, further comprising:
implementing graph processing techniques, the graph processing techniques comprising at least one of an intelligent topological search, an adaptive awareness‑based path finding, a depth‑first graph traversal, a breadth‑first graph traversal, a hardware architecture‑based selective navigation, and an intelligent acceleration technique.

7. The method as claimed in claim 1, wherein the human-in-the-loop verification agent is configured to evaluate the test plan using at least one of relevance to use case requirements, a constraint satisfaction accuracy, and one or more metrics associated with a predicted scenario coverage.

8. The method as claimed in claim 1, wherein the iteratively refining the test plan based on the validation feedback comprises feedback for at least one of knowledge adaptation, domain adaptation, and system adaptation.

9. The method as claimed in claim 1, wherein the plurality of test scenarios comprises random scenario vectors generated based on a user input.

10. The method as claimed in claim 1, wherein the system information comprises a hardware specification, a software configuration, architectural detail, the plurality of test scenarios, a data path aware constraint, and infrastructure availability.

11. The method as claimed in claim 1, wherein the use case information from the dataflow comprises at least one of an intellectual property (IP) level linkage in the system-on-chip, operational modes associated with the system-on-chip, and one or more data path definitions for decoding chain-level details.

12. A system for generating test scenarios, the system comprising:
a memory storing one or more instructions;
at least one processor , in communication with the one or more instructions stored in the memory , configured to:
extract configurable parameters and operable constraints from system information of a system-on-chip;
aggregate use case information from a dataflow, the configurable parameters, and the operable constraints;
identify, based on one or more artificial intelligence (AI) models , a hardware-software coordination mechanism based on the aggregated use case information;
generate, based on the one or more AI models, a knowledge graph, wherein generating the knowledge graph further comprises creating a use case profile based on the aggregated use case information and the hardware-software coordination mechanism;
instantiate at least a retrieval augmented generation agent configured to retrieve domain-specific information from the knowledge graph and a path optimization agent configured to determine traversal paths through the knowledge graph;
generate, based on the one or more AI models, a test plan based on the use case profile, the domain-specific information, and the traversal paths associated with the knowledge graph;
validate, based on the one or more AI models, the test plan by a human-in-the-loop verification agent;
iteratively refine the test plan based on validation feedback from the human-in-the-loop verification agent; and
generate, based on the one or more AI models, a plurality of test scenarios based on the validated and refined test plan.

13. The system as claimed in claim 12, wherein the one or more AI models comprises a generative AI model, and
wherein the generative AI model utilizes at least one of historical data, domain knowledge, and constraint definition records to generate a pattern-aware constraint encoding.

14. The system as claimed in claim 12, wherein the at least one processor is further configured to instantiate the path optimization agent to determine the traversal paths, and
wherein the instantiation comprises a hardware architecture aware selective navigation path optimization mechanism for reducing size of the knowledge graph and generating the test plan based on the use case profile and the knowledge graph.

15. The system as claimed in claim 12, wherein the at least one processor is further configured to generate the test plan based on at least logical reasoning and inductive input processing capabilities.

16. The system as claimed in claim 12, wherein the at least one processor is configured to:
implement a pruning strategy, based on properties of symmetry, to reduce a search space during constraint solving of the knowledge graph, wherein the pruning strategy comprises a Max-restricted path consistency mechanism.

17. The system as claimed in claim 12, wherein the at least one processor is further configured to:
implement graph processing techniques, the graph processing techniques comprising at least one of an intelligent topological search, an adaptive awareness‑based path finding, a depth‑first graph traversal, a breadth‑first graph traversal, a hardware‑based selective navigation, and an intelligent acceleration technique.

18. The system (130) as claimed in claim 12, wherein the human-in-the-loop verification agent is configured to evaluate the test plan using at least one of relevance to use case requirements, a constraint satisfaction accuracy, and one or more metrics associated with a predicted scenario coverage.

19. The system as claimed in claim 12, wherein the at least one processor is configured to iteratively refine generation of the plurality of test plan based on the validation feedback, and
wherein the validation feedback comprises feedback for at least one of knowledge adaptation, domain adaptation, and system adaptation.

20. A method for generating test scenarios, the method comprising:
generating a knowledge graph, wherein generating the knowledge graph comprises creating a use case profile based on use case information and a hardware-software coordination mechanism;
generating a test plan based on the use case profile, domain-specific information, and traversal paths associated with the knowledge graph;
validating the test plan by a human-in-the-loop verification agent;
iteratively refining the test plan based on validation feedback from the human-in-the-loop verification agent; and
generating a plurality of test scenarios based on the validated and refined test plan
